(19) United States
(12) Patent Application Publication
(10) Pub. No.: US 2015/0025671 A1
(43) Pub. Date: Jan. 22, 2015

(54) FOOD PRODUCT PREPARATION

(71) Applicant: NEXTECH INNOVATIONS LLC, Cleveland Heights, OH (US)

(72) Inventor: ALI ASSAR, CLEVELAND HEIGHTS, OH (US)

(73) Assignee: NEXTECH INNOVATIONS LLC, CLEVELAND HEIGHTS, OH (US)

(21) Appl. No.: 13/732,334

(22) Filed: Dec. 31, 2012

(51) Int. Cl. G06Q 10/06

(52) U.S. Cl. CPC G06Q 10/063
USPC 700/117

(57) ABSTRACT

Among other things, one or more techniques and/or systems are provided for preparing a food product. Data indicative of a first ingredient and a second ingredient of a food product (e.g., requested in an order) may be received. One or more indicators (e.g., LED lights) associated with the first ingredient and one or more indicators (e.g., LED lights) associated with the second ingredient may be selected.

### BACKGROUND

A food product may be prepared using one or more ingredients. The food product may, for example, comprise a sandwich, and may be prepared by an employee of a food provider (e.g., a restaurant). In one example, the food product may (e.g., as a result of an error by the employee) not comprise a first ingredient that it should (e.g., per the desire of a customer) comprise. In another example, the food product may comprise a second ingredient that it should not comprise. Alternatively and/or additionally, the food product may not be prepared in a timely manner.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques are described herein for selecting indicators associated with a food product. The food product may comprise, for example, a sandwich, a burrito, a wrap and/or a submarine sandwich. Data indicative of a first ingredient associated with the food product may be received. Data indicative of a second ingredient associated with the food product may be received. The first ingredient and/or the second ingredient may, for example, correspond to an order (e.g., from a customer, via a computer, etc.) for the food product. For example, the first ingredient may be lettuce, and the second ingredient may be tomatoes. One or more indicators associated with the first ingredient may be selected, and/or one or more indicators associated with the second ingredient may be selected. For example, a light corresponding to (e.g., wrapped around and/or located on a side of a first container comprising one or more pieces of) the first ingredient may be activated (e.g., turned on and/or illuminated), and/or a light corresponding to (e.g., wrapped around and/or located on a side of a second container (e.g., different than the first container) comprising one or more pieces of) the second ingredient may be activated (e.g., turned on and/or illuminated). In one embodiment, one or more indicators associated with the first ingredient and one or more indicators associated with the second ingredient may be selected concurrently. It may be appreciated that a user (e.g., an employee responsible for preparing the food product) may (e.g., manually) add (e.g., one or more pieces of) the first ingredient and/or (e.g., one or more pieces of) the second ingredient based upon the selection of the one or more indicators associated with the first ingredient and/or the selection of the one or more indicators associated with the second ingredient (e.g., and therefore, the user may not have to rely on text (e.g., printed and/or on a computer screen) to determine that the first ingredient and/or the second ingredient should be added).

The following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary method for food product preparation.

FIG. 2 is an illustration of an exemplary system for food product preparation.

FIG. 3 is an illustration of an exemplary system for food product preparation.

FIG. 4 is an illustration of an exemplary system for food product preparation.

FIG. 5 is an illustration of an exemplary system for food product preparation.

FIG. 6 is an illustration of an exemplary computer-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

A food product provider (e.g., a restaurant, etc.) may receive an order (e.g., for one or more products) from a customer. The order may be associated with a food product comprising, for example, a sandwich, a burrito, a wrap and/or a submarine sandwich. The food product may comprise one or more ingredients including, for example, a first ingredient and a second ingredient. It may be appreciated that a manager and/or owner of the food product provider may desire to avoid any errors in the preparation of the food product. For example, it may be desired to avoid adding one or more ingredients to the food product that are not comprised in the order (e.g., for one or more products) of the customer, and/or avoid not adding one or more ingredients to the food product that are comprised in the order (e.g., for one or more products) of the customer. It may also be appreciated that the manager and/or owner of the food product provider may desire to have the food product prepared efficiently and/or accurately. For example, it may be desired to decrease an amount of time that it takes to prepare the food product. In another example, it may be desired to make it easier for a preparer of the food product (e.g., an employee of the food product provider) to know which ingredient(s) to include in the food product and/or to prepare the food product without needing to read text (e.g., that is displayed a computer monitor and/or printed (e.g., on paper)) and/or listen to a customer.

Accordingly, among other things, one or more systems and/or techniques are provided herein for preparing a food product. In particular, data indicative of a first ingredient and a second ingredient of a food product may be received. One or more indicators associated with the first ingredient and one or more indicators associated with the second ingredient may be (e.g., selectively) selected. It may be appreciated that in some embodiments, one or more indicators may further be (e.g., selectively) selected that are associated with one or more other ingredients, food products and/or orders received from one or more users that are the same as a user associated with the food product, or different than the user associated with the food product. It may further be appreciated that at least some of the one or more systems and/or techniques provided herein may be used for preparing a product, device, and/or object (e.g., other than a food product).

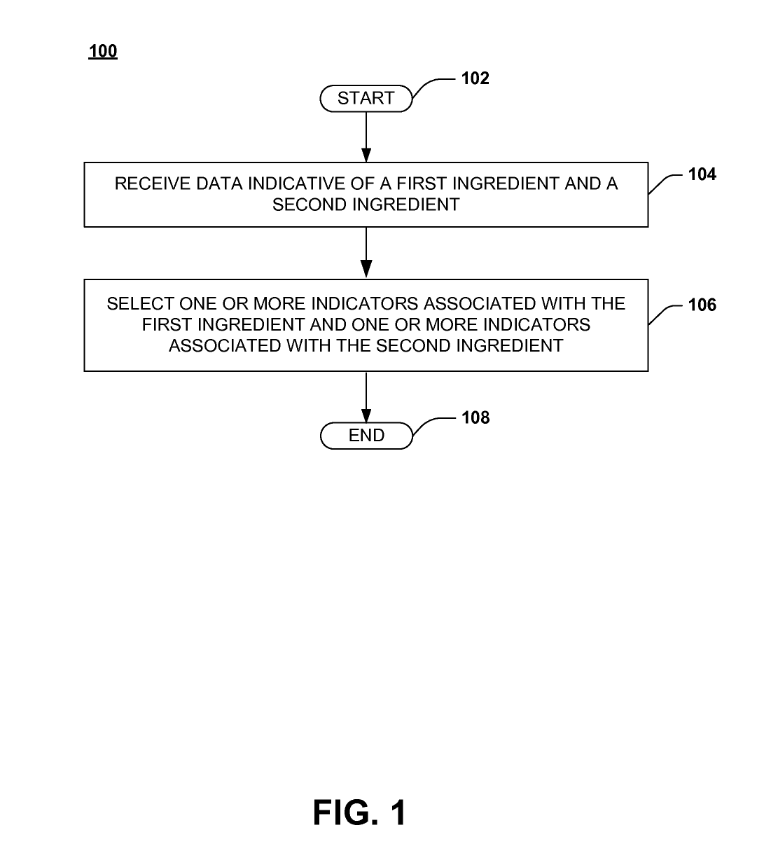

One embodiment of preparing a food product is illustrated by an exemplary method 100 in FIG. 1. At 102, the method starts. At 104, data indicative of a first ingredient (e.g., lettuce) and a second ingredient (e.g., chicken) may be received. The first ingredient and/or the second ingredient may, for example, be associated with a food product. For example, the first ingredient and/or the second ingredient may correspond to a food product requested by a customer via an order. At 106, one or more indicators associated with the first ingredient and/or one or more indicators associated with the second ingredient may be selected. In one embodiment, at least some of the one or more indicators may comprise one or more devices. For example, one or more optical devices (e.g., an LED light and/or another type of light) corresponding to the first ingredient and/or the second ingredient may be activated (e.g., turned on and/or illuminated). In the example, an optical device may be located on, above, under and/or near a location of the first ingredient and/or the second ingredient (e.g., an LED light may be adjacent to, under, shining down on and/or wrapped around a container (e.g., a tray) (e.g., comprising an open top (e.g., but no other open sides)) comprising the first ingredient and/or the second ingredient (e.g., but not one or more containers comprising one or more other ingredients)). In a second example, one or more motors corresponding to the first ingredient and/or the second ingredient may be activated (e.g., turned on). In the second example, a motor (e.g., an actuator) may be located on, above, under and/or near a location of the first ingredient and/or the second ingredient (e.g. a motor may lift and/or lower a container comprising the first ingredient and/or the second ingredient (e.g., such that the container comprising the first ingredient and/or the second ingredient may be located higher (e.g., vertically from a ground) than one or more other containers associated with one or more other ingredients (e.g., that are not associated with the food product))). In a third example, one or more physical devices (e.g., other than and/or not comprising an optical device and/or a motor) corresponding to the first ingredient and/or the second ingredient may be activated (e.g., turned on). At 108, the method ends.

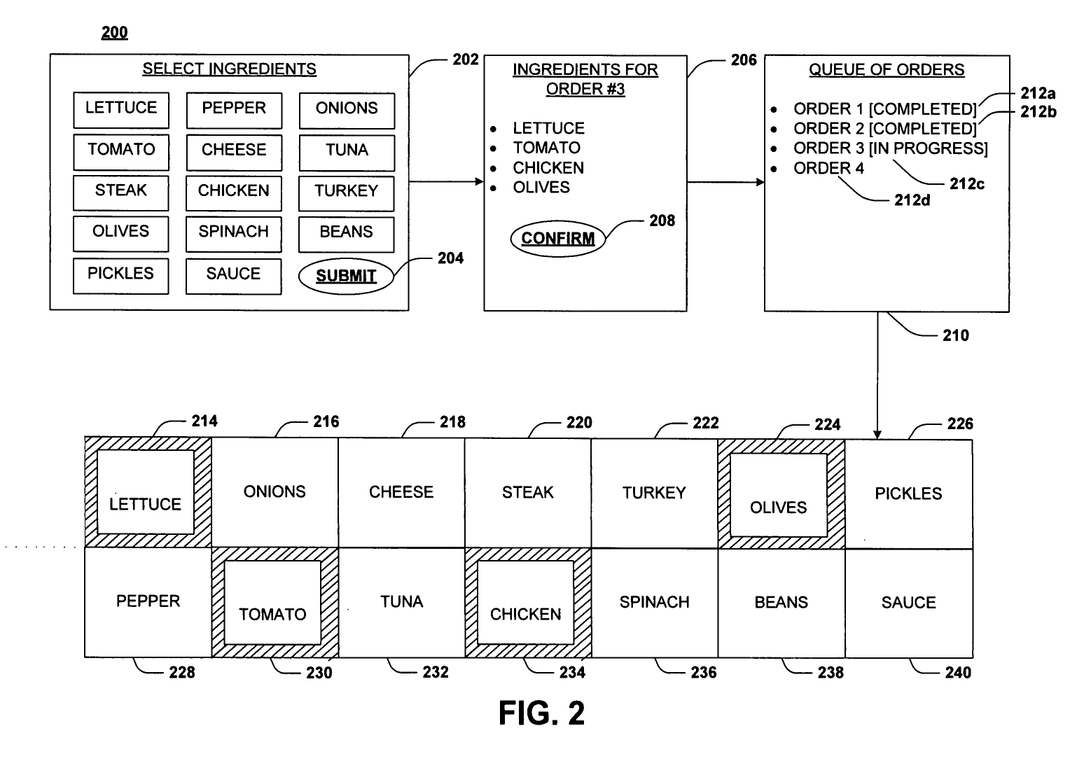

FIG. 2 illustrates an example of a system 200 configured for preparing a food product. The system 200 may comprise an interface 202. The interface 202 may be used by a user (e.g., a customer) to select one or more ingredients (e.g., desired by the user in a food product). The one or more ingredients may, for example, comprise lettuce, pepper, onions, tomato, cheese, tuna, steak, chicken, turkey, olives, spinach, beans, pickles, and/or sauce. It may be appreciated that in some embodiments, a user may, in addition to and/or instead of selecting one or more ingredients, select a sample food product (e.g., a vegetarian sandwich) which may be (e.g., automatically) associated with one or more (e.g., default) ingredients (e.g., bread, lettuce, tomatoes, and olives) (e.g., and/or the user may add one or more other ingredients and/or remove one or more (e.g., default) ingredients associated with the sample food product). After selecting one or more ingredients, the user may, for example, select a button 204 to submit the selected one or more ingredients. An order summary 206 may be provided, and may indicate one or more ingredients and/or food products selected by the user. The user may select a button 208 to confirm that the indicated one or more ingredients and/or food products accurately reflect a desired order of the user. In one embodiment, the order (e.g., comprising the selected and/or confirmed one or more ingredients and/or food products) may be placed in a queue 210. The queue 210 may, for example, comprise one or more orders (e.g., received from one or more users) and may, for example, indicate a status of an order. For example, the queue 210 may indicate that a first order is completed (e.g., 212a and/or 212b), that a second order is in progress (e.g., being prepared) (e.g., 212c), and/or that a third order is neither completed nor in progress (e.g., 212d).

One or more orders may be selected (e.g., based upon an order that they were received in) for preparation. For example, responsive to selecting a current order (e.g., for preparation), one or more indicators corresponding to one or more ingredients associated with the current order may be selected. For example, if the current order comprised lettuce, tomato, chicken, and/or olives, one or more lights (e.g., and/or other devices) associated with lettuce 214, one or more lights (e.g., and/or other devices) associated with tomato 230, one or more lights (e.g., and/or other devices) associated with chicken 234, and/or one or more lights (e.g., and/or other devices) associated with olives 224 may be activated (e.g., turned on and/or illuminated). It may be appreciated that a second user (e.g., an employee responsible for preparing the current order) may be enabled to easily identify which one or more ingredients should be used to prepare the current order.

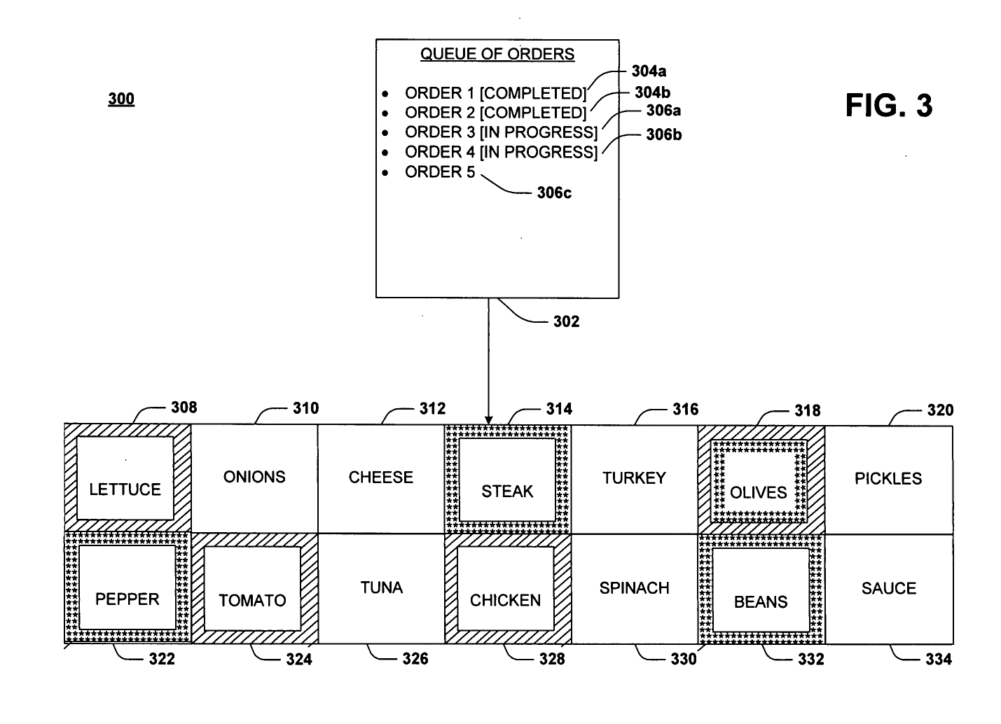

FIG. 3 illustrates an example of a system 300 configured for preparing a food product. In some embodiments, it may be appreciated that the system 300 may comprise an interface similar to interface 202 and/or an order summary similar to order summary 206. The system 300 may comprise a queue 302. The queue 302 may, for example, comprise one or more orders and may, for example, indicate a status of an order. For example, the queue 302 may indicate that a first order is completed (e.g., 304a and/or 304b), that a second order is in progress (e.g., 306a and/or 306b) (e.g., being prepared), and/or that a third order is neither completed nor in progress (e.g., 306c). More than one order may be selected (e.g., based upon an order that they were received in) for preparation. For example, responsive to selecting a first current order and a second current order, one or more indicators corresponding to one or more ingredients associated with the first current order may be selected, and one or more indicators corresponding to one or more ingredients associated with the second current order may be selected. It may be appreciated that the one or more indicators corresponding to one or more ingredients associated with the first current order may be different than (e.g., not the same as) the one or more indicators corresponding to one or more ingredients associated with the second current order. For example, there may be a difference in an optical representation (e.g., color, intensity, occurrence and/or activation of flashing and/or blinking, rate and/or pattern of flashing and/or blinking, and/or brightness) and/or in a physical representation (e.g., level of lifting and/or lowering), etc. For example, if the first current order comprised lettuce, tomato, chicken, and/or olives, one or more first colored lights associated with lettuce 308, one or more first colored lights associated with tomato 324, one or more first colored lights associated with chicken 328, and/or one or more first colored lights associated with olives 318 may be activated. In the example, if the second current order comprised pepper, steak, olives, and/or beans, one or more second colored lights associated with pepper 322, steak 314, olives 318, and/or beans 332 may be activated. In one embodiment, an ingredient (e.g., olives 318) that is associated with both the first current order and the second current order may have both a first colored light associated with the ingredient and a second colored light associated with the ingredient activated (e.g., concurrently). It may be appreciated that a second user (e.g., an employee responsible for preparing the first current order) may be enabled to easily identify which one or more ingredients should be used to prepare the first current order, while a third user (e.g., the same as or different than the second user) may be enabled to easily identify which one or more ingredients should be used to prepare the second current order, such that the first current order and the second order may be prepared at overlapping times (e.g., concurrently).

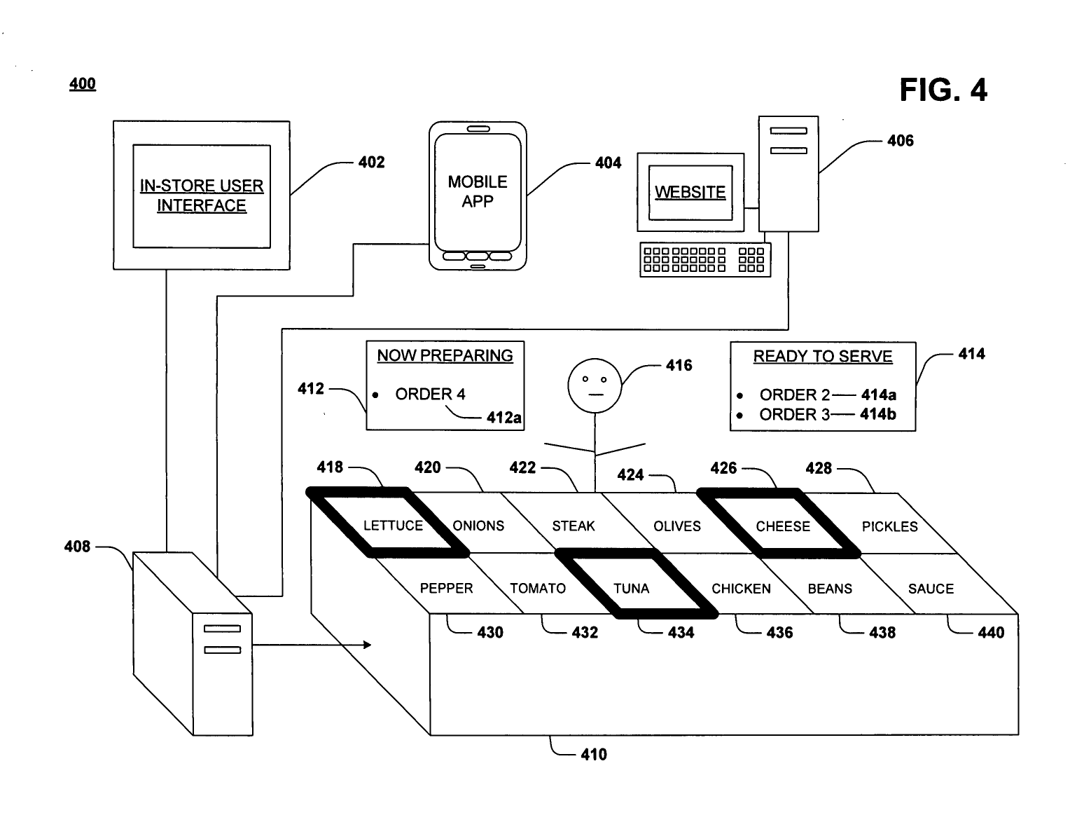

FIG. 4 illustrates an example of a system 400 configured for preparing a food product. The system 400 may comprise an in-store user interface 402, a mobile application 404 (e.g., which may also be referred to as a mobile app), and/or a website 406 that may be used (e.g., by a user) to provide (e.g., and/or prepare) a desired order for one or more food products (e.g., associated with one or more ingredients). For example, a food product provider (e.g., a restaurant) may have one or more in-store user interfaces 402 that may enable one or more customers located at a location associated with the food product provider (e.g., comprised in the restaurant) to place orders. The food product provider may alternatively and/or additionally provide a mobile application 404 that may, for example, be used by a customer (e.g., on a mobile device (e.g., a mobile phone, a tablet, etc.) of the customer). The food product provider may alternatively and/or additionally provide a website 406 that may, for example, be used by a customer (e.g., via a web browser and/or a computer) to place an order. One or more orders provided by an in-store user interface 402, a mobile application 404, and/or a website 406 may be received by (e.g., and/or provided to) a computer 408. The computer 408 may, for example, associate an order with a time received, a status (e.g., not prepared, in progress, and/or prepared), and/or a sequence (e.g., such that a first order may be placed in a queue for preparation before a second order (e.g., based upon a determination that the first order was received and/or provided before the second order, and/or based upon a time that the first order was requested to be ready by in comparison to a time that the second order was requested to be ready by)). The computer 408 may provide data and/or a signal to a (e.g., food) preparation area 410. The preparation area 410 may, for example, comprise one or more containers comprising one or more ingredients. The data and/or signal provided by the computer 408 may correspond to one or more orders. For example, responsive to the computer 408 selecting a current order (e.g., from a queue), data indicative of one or more ingredients associated with the current order may be provided to the preparation area 410. In response, one or more indicators corresponding to one or more ingredients associated with the current order may be selected. For example, if the current order comprised lettuce, tuna, and/or cheese, one or more lights (e.g., and/or other devices) associated with lettuce 418, one or more lights (e.g., and/or other devices) associated with tuna 434, and/or one or more lights (e.g., and/or other devices) associated with cheese 426 may be activated (e.g., turned on and/or illuminated).

It may be appreciated that in some embodiments, the system 400 may comprise one or more other components not illustrated by FIG. 4 that may be configured to receive one or more orders. For example, an audio system may receive a (e.g., telephone) call from a customer, and (e.g., via a prompt) enable the customer to place an order for one or more (e.g., food) products and/or one or more ingredients. In one embodiment of the audio system, the customer may select (e.g., press) a first button (e.g., on a phone of the customer) to select a first food product and/or a first ingredient and/or select (e.g., press) a second button (e.g., on the phone of the customer) to select a second food product and/or a second ingredient, etc. In another embodiment of the audio system, the customer may say a first word (e.g., and/or provide first audio (e.g., to the audio system)) to select the first food product and/or the first ingredient and/or say a second word (e.g., and/or provide second audio (e.g., to the audio system)) to select the second food product and/or the second ingredient.

It may be appreciated that a second user (e.g., an employee 416 responsible for preparing the current order) may be enabled to easily and/or conveniently identify which one or more ingredients should be used to prepare the current order. It may further be appreciated that in one embodiment, at least some of the system 300 in FIG. 3 may be incorporated into the system 400 of FIG. 4, such that, for example, one or more indicators corresponding to one or more ingredients associated with the current order may be different than (e.g., not the same as) one or more indicators corresponding to one or more ingredients associated with a second current order (e.g., such that more than one order (e.g., the current order and a second current order) may conveniently, accurately and/or efficiently be prepared at overlapping times (e.g., concurrently)). In one embodiment, a first device 412 may, for example, indicate (e.g., display) one or more orders that are being prepared (e.g., 412a) (e.g., such that preparation has begun, but has not been completed), and/or a second device 414 may, for example, indicate (e.g., display) one or more orders that have been completed (e.g., 414a and/or 414b) (e.g., and are therefore ready to serve to one or more customers). The first device 412 may be the same as or different than the second device 414, for example.

In another embodiment, a preparation area may comprise one or more areas. Each of the one or more areas may comprise one or more ingredients and may correspond to a phase of preparation of a current order. For example, a first area in the preparation area may comprise a first ingredient and a second ingredient (e.g., and/or one or more other ingredients), and a second area (e.g., that is different than the first area) may comprise a third ingredient and a fourth ingredient (e.g., and/or one or more other ingredients). In the example, the current order may be associated with the first ingredient, the second ingredient, the third ingredient and/or the fourth ingredient. At a first phase (e.g., at a first time), one or more indicators associated with one or more ingredients that are associated with the current order and are comprised in the first area (e.g., the first ingredient and the second ingredient) may be selected (e.g., but one or more indicators associated with one or more ingredients that are associated with the current order and are not comprised in the first area and/or are comprised in another area may not be selected). At a second phase (e.g., at a second time (e.g., different than the first time)) (e.g., which may be started in response to receiving (e.g., user) input (e.g., indicating that preparation of one or more ingredients associated with the first phase has been completed)), one or more indicators associated with one or more ingredients that are associated with the current order and are comprised in the second area (e.g., the third ingredient and the fourth ingredient) may be selected (e.g., but one or more indicators associated with one or more ingredients that are associated with the current order and are not comprised in the second area and/or are comprised in another area may not be selected). It may further be appreciated that at least some of the system 300 in FIG. 3 may be incorporated, such that, for example, one or more indicators corresponding to one or more ingredients associated with a second current order (e.g., that is different than the current order) may (e.g., also) be selected in one or more phases (e.g., such that one or more indicators corresponding to one or more ingredients that are associated with the second current order and/or are comprised in the first area may be selected during a first phase associated with the second current order, and/or one or more indicators corresponding to one or more ingredients that are associated with the second current order and/or are comprised in the second area may be selected during a second phase associated with the second current order), where the one or more indicators corresponding to one or more ingredients associated with the current order may be different than (e.g., not the same as) (e.g., in terms of color, intensity, etc.) the one or more indicators corresponding to one or more ingredients associated with the second current order.

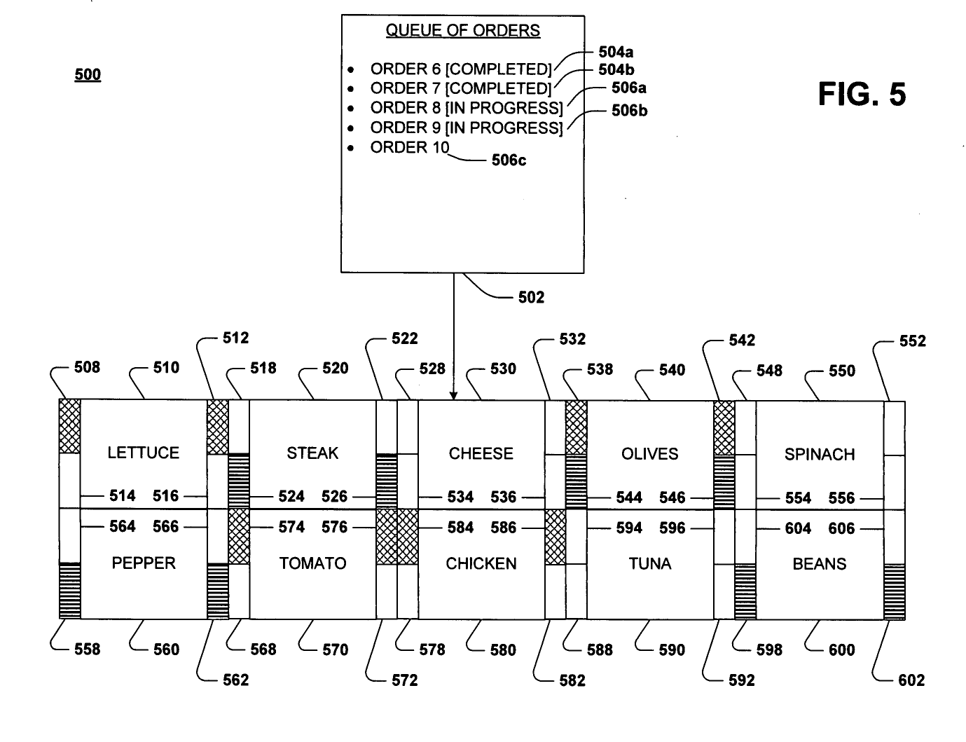

FIG. 5 illustrates an example of a system 500 configured for preparing a food product. In some embodiments, it may be appreciated that the system 500 may comprise an interface similar to interface 202 and/or an order summary similar to order summary 206. The system 500 may comprise a queue 502. The queue 502 may, for example, comprise one or more orders and may, for example, indicate a status of an order. For example, the queue 502 may indicate that a first order is completed (e.g., 504a and/or 504b), that a second order is in progress (e.g., being prepared) (e.g., 506a and/or 506b), and/or that a third order is neither completed nor in progress (e.g., 506c). More than one order may be selected (e.g., based upon an order that they were received in) for preparation. For example, responsive to selecting a first current order and a second current order, one or more indicators corresponding to one or more ingredients associated with the first current order may be selected, and one or more indicators corresponding to one or more ingredients associated with the second current order may be selected. It may be appreciated that the one or more indicators corresponding to one or more ingredients associated with the first current order may be different than (e.g., not the same as) the one or more indicators corresponding to one or more ingredients associated with the second current order. For example, there may be a difference in an optical representation (e.g., color, intensity, occurrence and/or activation of flashing and/or blinking, rate of flashing and/or blinking and/or brightness) and/or in a physical representation (e.g., level of lifting and/or lowering), etc.

One or more ingredients (e.g., and/or a container comprising and/or associated with one or more ingredients) may be adjacent to and/or near one or more indicators corresponding to the first current order and one or more indicators corresponding to the second current order. One or more indicators corresponding to the first current order may be comprised in a first portion (e.g., an upper portion and/or half) of a first side (e.g., and/or a second side) (e.g., where a side may be a left side, a right side, a top side, and/or a bottom side) of an ingredient (e.g., and/or a container comprising and/or associated with the ingredient), and/or one or more indicators corresponding to the second current order may be comprised in a second portion (e.g., a lower portion and/or half) of the first side (e.g., and/or the second side) of the ingredient (e.g., and/or a container comprising and/or associated with the ingredient) (e.g., when viewed from an aerial view). For example, if the first current order comprised lettuce, tomato, chicken, and/or olives, one or more first colored lights (e.g., and/or other devices) on an upper portion 508 of a first side of lettuce 510 and/or an upper portion 512 of a second side of lettuce 510, one or more first colored lights (e.g., and/or other devices) on an upper portion 574 of a first side of tomato 570 and/or an upper portion 576 of a second side of tomato 570, one or more first colored lights (e.g., and/or other devices) on an upper portion 584 of a first side of chicken 580 and/or an upper portion 586 of a second side of chicken 580, and/or one or more first colored lights (e.g., and/or other devices) on an upper portion 538 of a first side of olives 540 and/or an upper portion 542 of a second side of olives 540 may be activated (e.g., turned on and/or illuminated). In the example, if the second current order comprised pepper, steak, olives, and/or beans, one or more second colored lights (e.g., and/or other devices) on a lower portion 558 of a first side of pepper 560 and/or a lower portion 562 of a second side of pepper 560, one or more second colored lights (e.g., and/or other devices) on a lower portion 524 of a first side of steak 520 and/or a lower portion 526 of a second side of steak 520, one or more second colored lights (e.g., and/or other devices) on a lower portion 544 of a first side of olives 540 and/or a lower portion 546 of a second side of olives 540, and/or one or more second colored lights (e.g., and/or other devices) on a lower portion 598 of a first side of beans 600 and/or a lower portion 602 of a second side of beans 600 may be activated (e.g., turned on and/or illuminated). In one embodiment, an ingredient (e.g., olives 540) that is associated with both the first current order and the second current order may have (e.g., both) one or more first colored lights (e.g., and/or other devices) on a first portion (e.g., an upper portion) of a first side (e.g., and/or a second side) of the ingredient and one or more second colored lights (e.g., and/or other devices) on a second portion (e.g., a lower portion) of the first side (e.g., and/or a second side) of the ingredient may be activated (e.g., turned on and/or illuminated) (e.g., concurrently) (e.g., such that one or more lights and/or other devices that are activated in association with the first current order may be next to and/or adjacent to one or more lights and/or other devices that are activated in association with the second current order).

It may be appreciated that a second user (e.g., an employee responsible for preparing the first current order) may be enabled to easily identify which one or more ingredients should be used to prepare the first current order, while a third user (e.g., the same as or different than the second user) may be enabled to easily identify which one or more ingredients should be used to prepare the second current order, such that the first current order and the second order may be prepared at overlapping times (e.g., concurrently).

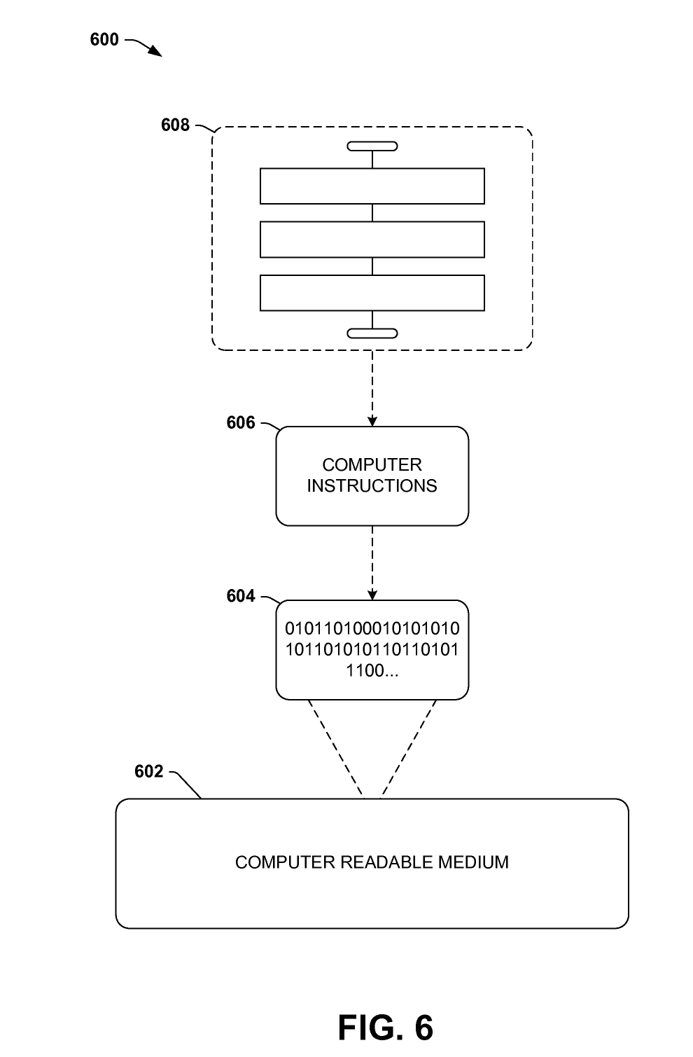

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 602 (e.g., a CD-R, DVD-R, or a platter of a hard disk drive), on which is encoded computer-readable data 604. This computer-readable data 604 in turn comprises a set of computer instructions 606 configured to operate according to one or more of the principles set forth herein. In one such embodiment 600, the processor-executable computer instructions 606 may be configured to perform a method, such as at least some of the exemplary method 100 of FIG. 1, for example. In another such embodiment, the processor-executable instructions 606 may be configured to implement a system, such as at least some of the exemplary system 200 of FIG. 2, at least some of the exemplary system 300 of FIG. 3, at least some of the exemplary system 400 of FIG. 4, and/or at least some of the exemplary system 500 of FIG. 5, for example. Many such computer-readable media 602 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

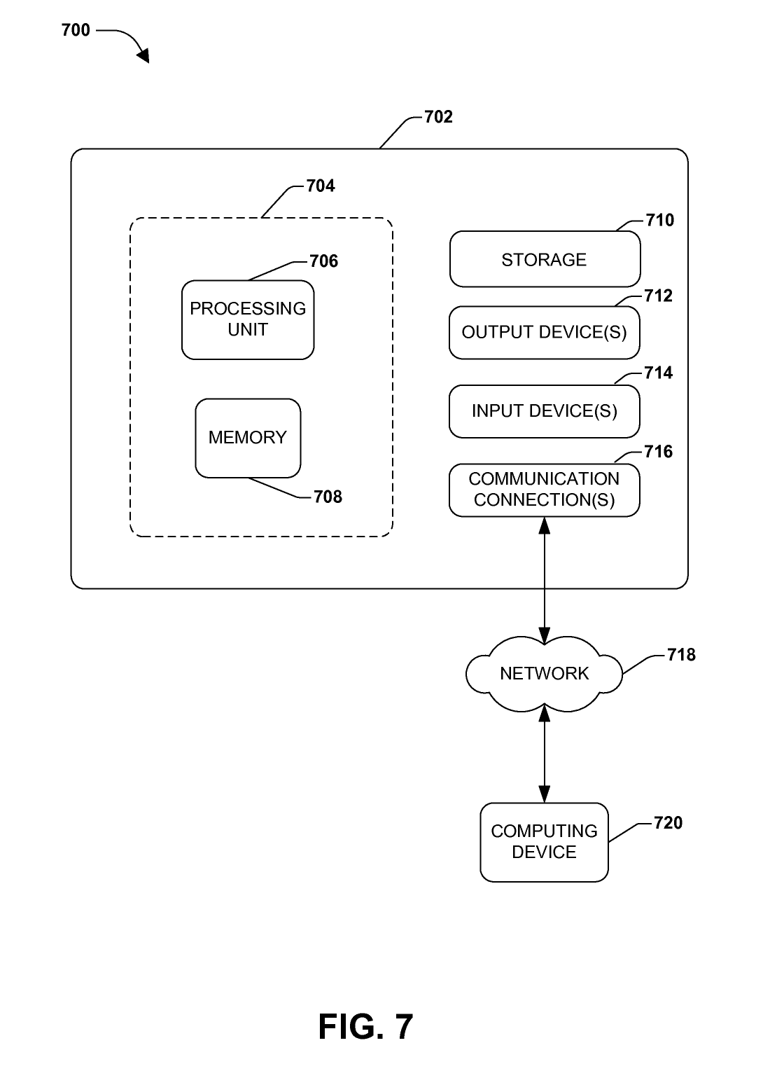

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 702 configured to implement one or more embodiments provided herein. In one configuration, computing device 702 includes at least one processing unit 706 and memory 708. Depending on the exact configuration and type of computing device, memory 708 may be volatile (such as RAM, for example), non-volatile (such as ROM, flash memory, etc., for example), or some combination of the two. This configuration is illustrated in FIG. 7 by dashed line 704.

In other embodiments, device 702 may include additional features and/or functionality. For example, device 702 may also include additional storage (e.g., removable and/or non-removable) including, but not limited to, magnetic storage, optical storage, and the like. Such additional storage is illustrated in FIG. 7 by storage 710. In one embodiment, computer readable instructions to implement one or more embodiments provided herein may be in storage 710. Storage 710 may also store other computer readable instructions to implement an operating system, an application program, and the like. Computer readable instructions may be loaded in memory 708 for execution by processing unit 706, for example.

The term “computer readable media” as used herein includes computer storage media. Computer storage media includes volatile and nonvolatile, removable and non-removable media implemented in any method or technology for storage of information such as computer readable instructions or other data. Memory 708 and storage 710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 702. Any such computer storage media may be part of device 702.

Device 702 may also include communication connection(s) 716 that allows device 702 to communicate with other devices. Communication connection(s) 716 may include, but is not limited to, a modem, a Network Interface Card (NIC), an integrated network interface, a radio frequency transmitter/receiver, an infrared port, a USB connection, or other interfaces for connecting computing device 702 to other computing devices. Communication connection(s) 716 may include a wired connection or a wireless connection. Communication connection(s) 716 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 702 may include input device(s) 714 such as keyboard, mouse, pen, voice input device, touch input device, infrared cameras, video input devices, and/or any other input device. Output device(s) 712 such as one or more displays, speakers, printers, and/or any other output device may also be included in device 702. Input device(s) 714 and output device(s) 712 may be connected to device 702 via a wired connection, wireless connection, or any combination thereof. In one embodiment, an input device or an output device from another computing device may be used as input device(s) 714 or output device(s) 712 for computing device 702.

Components of computing device 702 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 702 may be interconnected by a network. For example, memory 708 may be comprised of multiple physical memory units located in different physical locations interconnected by a network.

Those skilled in the art will realize that storage devices utilized to store computer readable instructions may be distributed across a network. For example, a computing device 720 accessible via a network 718 may store computer readable instructions to implement one or more embodiments provided herein. Computing device 702 may access computing device 720 and download a part or all of the computer readable instructions for execution. Alternatively, computing device 702 may download pieces of the computer readable instructions, as needed, or some instructions may be executed at computing device 702 and some at computing device 720.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based at least in part upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1-20. (canceled)

21. A method, comprising:
receiving first data, associated with a first food product, indicative of a first ingredient and a second ingredient, the first data corresponding to a first order of a first user of a first computer;
responsive to the receiving the first data, placing the first order in a queue;
receiving second data, associated with a second food product, indicative of a third ingredient and a fourth ingredient, the second data corresponding to a second order of a second user of a second computer, the first order different than the second order, the first user different than the second user, the first computer different than the second computer, the first data and the second data received by a same computer;
responsive to the receiving the second data, placing the second order in the queue;
responsive to a first selection of the first order from the queue, activating, in association with the first food product:
a first optical device associated with a first container of the first ingredient; and
a second optical device associated with a second container of the second ingredient, the first container different than the second container; and
responsive to a second selection of the second order from the queue, activating, in association with the second food product and concurrently with the activating of the first optical device and the second optical device:
a third optical device associated with a third container of the third ingredient; and
a fourth optical device associated with a fourth container of the fourth ingredient, the third container different than the fourth container, where the first optical device and the second optical device, while activated, are associated with a first optical representation that is different than a second optical representation associated with the third optical device and the fourth optical device, while activated,
where a fifth optical device associated with a fifth ingredient that is not indicated by the first data and is not indicated by the second data is not activated during the activating of the first optical device and the second optical device and during the activating the third optical device and the fourth optical device, the first optical device different than the third optical device, the first optical device different than the fourth optical device, the first optical device different than the fifth optical device, the second optical device different than the third optical device, the second optical device different than the fourth optical device, the second optical device different than the fifth optical device, the third optical device different than the fifth optical device, the fourth optical device different than the fifth optical device.

22. The method of claim 21, the first optical representation corresponding to a first color, the second optical representation corresponding to a second color.

23. The method of claim 22, the first color different than the second color.

24. The method of claim 21, the first ingredient the same as the third ingredient and the first container the same as the third container.

25. The method of claim 24, the first container, which is the same as the third container, associated with both the first optical device and the third optical device such that the first optical device and the third optical device are concurrently activated but are associated with different optical representations.

26. The method of claim 21, at least one of the first data or the second data received via at least one of a website, a mobile device application, an audio system or a user interface comprised in a provider of at least one of the first food product or the second food product.

27. The method of claim 21 implemented at least in part via a processing unit.

28. A system configured to perform a method comprising:
receiving first data, associated with a first food product, indicative of a first ingredient and a second ingredient, the first data corresponding to a first order of a first user of a first computer;
receiving second data, associated with a second food product, indicative of a third ingredient and a fourth ingredient, the second data corresponding to a second order of a second user of a second computer, the first order different than the second order, the first user different than the second user, the first computer different than the second computer, the first data and the second data received by a same computer;
based upon the first data, activating, in association with the first food product:
a first optical device associated with a first container of the first ingredient; and
a second optical device associated with a second container of the second ingredient, the first container different than the second container; and
based upon the second data, activating, in association with the second food product and concurrently with the activating of the first optical device and the second optical device:
a third optical device associated with a third container of the third ingredient; and
a fourth optical device associated with a fourth container of the fourth ingredient, where the first optical device and the second optical device, while activated, are associated with a first optical representation that is different than a second optical representation associated with the third optical device and the fourth optical device, while activated,
where a fifth optical device associated with a fifth ingredient that is not indicated by the first data and is not indicated by the second data is not activated during the activating of the first optical device and the second optical device and during the activating the third optical device and the fourth optical device, the first optical device different than the third optical device, the first optical device different than the fourth optical device, the first optical device different than the fifth optical device, the second optical device different than the third optical device, the second optical device different than the fourth optical device, the second optical device different than the fifth optical device, the third optical device different than the fifth optical device, the fourth optical device different than the fifth optical device.

29. The system of claim 28, the first optical representation corresponding to a first color, the second optical representation corresponding to a second color.

30. The system of claim 29, the first color different than the second color.

31. The system of claim 28, the first ingredient the same as the third ingredient and the first container the same as the third container.

32. The system of claim 31, the first container, which is the same as the third container, associated with both the first optical device and the third optical device such that the first optical device and the third optical device are concurrently activated but are associated with different optical representations.

33. The system of claim 28, at least one of the first data or the second data received via at least one of a website, a mobile device application, an audio system or a user interface comprised in a provider of at least one of the first food product or the second food product.

34. The system of claim 28 implemented at least in part via a processing unit.

35. A method, comprising:
receiving first data, associated with a first food product, indicative of a first ingredient and a second ingredient, the first data corresponding to a first order of a first user of a first computer;
receiving second data, associated with a second food product, indicative of a third ingredient and a fourth ingredient, the second data corresponding to a second order of a second user of a second computer, the first order different than the second order, the first user different than the second user, the first computer different than the second computer, the first data and the second data received by a same computer;
based upon the first data, activating, in association with the first food product, a first optical device associated with the first ingredient and a second optical device associated with the second ingredient; and
based upon the second data, activating, in association with the second food product and concurrently with the activating of the first optical device and the second optical device, a third optical device associated with the third ingredient and a fourth optical device associated with the fourth ingredient, where the first optical device and the second optical device, while activated, are associated with a first optical representation that is different than a second optical representation associated with the third optical device and the fourth optical device, while activated,
where a fifth optical device associated with a fifth ingredient that is not indicated by the first data and is not indicated by the second data is not activated during the activating of the first optical device and the second optical device and during the activating the third optical device and the fourth optical device.

36. The method of claim 35 implemented at least in part via a processing unit.

37. The method of claim 35, the first optical representation corresponding to a first color, the second optical representation corresponding to a second color, the first color different than the second color.

38. The method of claim 35, the first ingredient the same as the third ingredient and the first container the same as the third container.

39. The method of claim 38, the first container, which is the same as the third container, associated with both the first optical device and the third optical device such that the first optical device and the third optical device are concurrently activated but are associated with different optical representations.

40. The method of claim 35, at least one of the first data or the second data received via at least one of a website, a mobile device application, an audio system or a user interface comprised in a provider of at least one of the first food product or the second food product.
